(19) United States
(12) Patent Application Publication
(10) Pub. No.: US 2020/0358194 A1
(43) Pub. Date: Nov. 12, 2020

(54) Antenna For Communicating With A Transponder

(71) Applicant: Turck Holding GmbH, Halver (DE)

(72) Inventor: Michael Reppel, Herner (DE)

(73) Assignee: Turck Holding GmbH, Halver (DE)

(21) Appl. No.: 16/966,046

(22) PCT Filed: Feb. 13, 2019
(86) PCT No.: PCT/EP2019/053477

§ 371 Date: Jul. 30, 2020

(30) Foreign Application Priority Data
Feb. 14, 2018 (DE) 10 2018 103 288.9

(51) Int. Cl. H01Q 9/04; H01Q 19/10

(52) U.S. Cl. CPC H01Q 9/045; H01Q 9/0428; H01Q 9/0414; H01Q 19/10

(57) ABSTRACT

A device for exchanging data with a transponder. A first antenna surface extends on a broad-side surface of a dielectric body. A reflection surface is provided on the opposite broad-side surface. At the back of the reflection surface there is a feed network for providing a phase-shifted alternating voltage, which is coupled into the antenna surface at a plurality of different feed points by means of feed elements penetrating the reflection surface in an isolated manner. A second antenna surface is spaced apart from the first antenna surface at a distance by means of spacers.

### TECHNICAL FIELD

An antenna arrangement consisting of a first antenna, a reflector and an antenna feed network is disclosed in “Broad-Band Single-Patch Circularly Polarized Microstrip Antenna with Dual Capacitively Coupled Feeds”, IEEE TRANSACTIONS ON ANTENNAS AND PROPAGATION, VOL. 49, NO. 1, JANUARY 2001.

A feed network consisting of microstrips is located on the rear side of a first printed circuit board, which feed network capacitively couples AC voltage signals into a circular disk-shaped antenna at two feed locations, which are different from one another. The AC voltages are phase-shifted by 90°, so that the antenna surface transmits electromagnetic waves, which are perpendicular to one another and phase-shifted by 90° and which are circularly polarized owing to their phase shift. The amplitude difference of the partial waves, which are at 90° to one another, is up to 3 dB there.

Planar antennas of this type are used in order to exchange data with RFIDs in the 900 MHz band and in order to transmit energy to transponders of this type wirelessly. By means of the energy transmitted to the transponder, the memory IC of the transponder is enabled to wirelessly transmit data to the antenna arrangement or wirelessly receive information from the antenna arrangement. The operating frequency lies in the range between 840 MHz and 960 MHz. In order to be able to carry out the data communication independently of the polarization of the electromagnetic waves, the electromagnetic signal is circularly polarized.

### BACKGROUND

A planar antenna according to the above-mentioned prior art has a first metal surface, which is used as an antenna element for transmitting and receiving. A second, larger metal surface is used as reflector and rear shield. In the prior art, the spacing of the two metal surfaces is typically 5 to 25 mm. The lateral dimension of the antenna element is approximately 150 mm, that is to say approximately half the free-space wavelength of the frequency range mentioned. The reflector is larger than the antenna element and has a lateral dimension of approximately 200 mm. As a consequence of the rear shield, it is possible to fasten the antenna arrangement flat on a wall. Furthermore, the RFID control electronics may be arranged directly to the rear of the antenna or the reflector. Owing to the plurality of feed-in locations, it is possible to receive or to transmit linearly or circularly polarized electromagnetic waves. The axial ratio should not lie below one dB in this case.

Subbands of the above-mentioned 900 MHz band, which differ from one another regionally, are used. Subbands in the range below 900 MHz and subbands above 900 MHz may be used. In the prior art, the antenna arrangement only has an optimum transmit/receive behavior in the region of a maximum, which is usually 900 MHz, if it is an antenna which can be used universally, or which is in the middle of one of the subbands used. In the latter case, this antenna is only optimally suitable for use in the respective subband.

CN 106 356 620 A1 describes an antenna arrangement consisting of two dielectric bodies, which are spaced from one another and carry metal layers in each case. An upper dielectric body carries an antenna constructed with interrupt structures. A lower dielectric body carries an antenna formed by a metal layer, which is connected by means of feed-in elements to a microstrip structure.

### SUMMARY

The invention is based on the object of specifying an antenna arrangement for communicating with a transponder in the 900 MHz band, which is to be manufactured cost effectively, which has a transmit/receive behavior which is as frequency-independent as possible. In addition, there is the requirement of configuring the antenna in such a manner that it generates circularly polarized waves, which are as ideal as possible, in order to detect the spatially movable RFID tags independently of their orientation.

The object is achieved by the invention specified in the claims. The dependent claims not only represent advantageous developments of the main claim, but rather also independent solutions of the object. The field of application of a generic planar antenna for communication with an RFID tag is enlarged using the features mentioned in the claims.

The device according to the invention is an antenna arrangement for data exchange with a transponder and for energy transmission to a transponder, particularly in the 900 MHz band. A first antenna surface for transmitting and receiving electromagnetic waves is provided. A reflection surface extends to the rear and parallel to the first antenna surface. The surface normal directed away from the antenna surface away from the reflector surface defines a direction of action, in which the electromagnetic waves can be transmitted or from which the electromagnetic waves can be received from the transponder. The antenna surface has a first spacing from the reflection surface. The space between first antenna surface and reflection surface is preferably filled completely by a dielectric body, which is preferably a circuit board, so that the first spacing lies in the range between 0.5 and 3 mm. In a variant, it is provided that an additional metalization is arranged between the first antenna surface and the reflection surface, which preferably has no electrical effect. The additional metalization is electrically separated from the antenna surface and the reflection surface by means of two dielectric bodies. The additional metalization may extend between two dielectric bodies. It is in particular provided that the antenna surface is formed by a first metalization, which extends on a planar surface of a supporting body. The reflection surface is a metalization of a second surface of the supporting body, wherein the two surfaces run parallel to one another and the supporting body is substantially dielectric. A microstrip structure is located on the rear side of the reflection surface—with respect to the direction of action. A dielectric body is likewise located between microstrip structure and reflection surface. The microstrip structure may be formed by metal strips of a circuit board and forms a feed network. The feed network, the reflection surface and the first antenna surface may be realized by a three-layered circuit board, wherein the two outwardly facing metalization surfaces are structured by etching or mechanical actions, namely to form a first antenna surface and to form a feed network, which consists of one or more microstrips, the length of which causes phase shifts. In a variant, the feed network, the reflection surface and the first antenna surface are realized by an at least four-layered circuit board. Here, it is preferably provided that a further, particularly electrically inert metalization (dummy metalization), is arranged between the first antenna surface and the reflection surface. The microstrip structure is used for providing phase-shifted AC voltage signals. Four feed-in locations are preferably provided, at which AC voltage signals, which are phase-shifted by 90° in each case, are coupled into the first antenna surface. Preferably, these are feed-in locations, at which the AC voltage signal is fed in with phase positions of 0°, 90°, 180° and 270°. To this end, the feed-in locations are preferably arranged in a fourfold symmetry about an axis of symmetry of the first antenna surface. Feeding in takes place capacitively, preferably however galvanically, which is why feed-in elements are used, which penetrate the reflection surface in an insulating manner at a plurality of locations, which differ from one another. These may be contact pins in this case, which galvanically connect the microstrip structure to the feed-in locations of the first antenna surface. The antenna surface is therefore able to transmit circularly polarized or else also linearly polarized electromagnetic waves. The first spacing is substantially smaller than the guided wavelength, that is to say the wavelength which is formed at the working frequency inside the dielectric body. The lateral dimensions of the antenna surface are chosen such that two standing waves, which are perpendicular to one another are created there. The spacing between reflection surface and first antenna surface is in particular smaller than a tenth of the vacuum wavelength. The spacing between the feed network and the reflector may be smaller than the spacing between first antenna surface and reflector. The spacing between feed network and reflector may lie in the range between 0.1 and 3 mm. The feed network may have two feed-in points, which are connected to the microstrip structure in such a manner that a counterclockwise or a clockwise polarized wave is formed, depending on the choice of the feed-in point. The circuit board preferably consists of the composite material FR4 with three or four metalization planes made from copper. The first antenna surface is located on a topmost plane. The central plane in a three-layered circuit board is virtually completely metalized and forms an antenna reflector as a result. The central plane is used at the same time as a shield for the feed network, which is located on the lowermost plane. The feed network is preferably formed by microstrip lines and is connected to the feed-in locations using plated through holes. The feed-in points for connection to a 50 ohm transmission line may be formed by coaxial SMD plug connectors. They may be fastened there by means of standard reflow soldering methods, in order to connect the antenna to the RFID control electronics. The feed-in elements, which connect the feed-in locations of the antenna surface to the feed network, penetrate the reflection surface in a manner insulated from the reflection surface. In the variant, in which a further metalization is located between the reflection surface and the antenna surface, the feed-in elements also penetrate the metalization in a manner insulated from the metalization. The metalization is an intermediate layer between two dielectric layers. In this variant, the antenna surface is spaced from the reflection surface by the material thickness of two dielectric bodies and a metalization arranged therebetween. The strongly reduced spacing compared to the prior art, that is to say the section between reflection surface and first antenna surface, filled by the dielectric, leads—considered alone—to an impairment of the transmit/receive behavior. The antenna arrangement according to the invention compensates this possible disadvantage with a second antenna surface, which is spaced from the first antenna surface in the direction of action with a third spacing. This spacing is smaller than a quarter of the wavelength resulting with the dielectric constant in the space between first antenna surface and second antenna surface. However, the spacing is greater than the first spacing, that is to say the spacing between first antenna surface and reflection surface. The second antenna surface may be a metal surface, which extends on a second circuit board or on a comparable support material. In this case, the metal surface may face towards the first antenna surface, so that the dielectric constant in the space is essentially the dielectric constant of air. The second antenna surface may however also be arranged on the support material, directed away from the first antenna surface, so that the support material, which is thin compared to the third spacing, may contribute slightly to the dielectric properties of the space. The support supporting the second antenna surface may be connected by means of electrically conductive or non-conductive spacers to the dielectric body which supports the first antenna surface. Preferably, all metalizations are metal layers of circuit boards, so that the spacers essentially connect two circuit boards to one another, wherein the circuit boards extend parallel to one another. The first antenna surface and the second antenna surface are preferably insulated with respect to one another, so that there is no galvanic connection between the two antenna surfaces. In a variant of the invention, it is provided that the second antenna surface is realized by a metal surface of a housing. The housing may have a housing lower part and a housing upper part. The housing lower part may be produced from a non-conductive material, preferably however from an electrically conductive material. The housing cover is preferably non-conductive and consists for example from PC-ABS or polyamide-6 (PA6). The second antenna surface may in this case be realized by various methods, for example a metal foil or a thin metal foil may be adhesively bonded, clipped or pressed into the cover of the housing. This metal surface may be applied on a further, non-conductive support. Two-component injection molding or laser direct structuring are also provided. It is further preferably provided, that the second antenna surface is coupled to the first antenna surface by means of an electromagnetic field exclusively. The third spacing, that is to say the spacing between the two antenna surfaces, which may also fundamentally be termed antenna elements in the sense of the invention, influences the transmit/receive behavior. A small spacing between the antenna elements leads to a strong coupling of the antenna elements. This coupling is weaker in the case of a large spacing. Strong coupling leads to splitting of the resonant frequency into a lower resonant frequency and to an upper resonant frequency. In order to keep the spacing between the antenna surfaces as low as possible, which is beneficial for the envisaged flat structural form of the overall device, one of the antenna surfaces is interrupted according to the invention with interrupt structures. The interrupt structures are metalization-free zones of the otherwise closed antenna surface, for example, the interrupt structures may be insular free spaces in an otherwise completely metalized surface. It is, however, also possible to divide the antenna surfaces into a plurality of partial surfaces, which are galvanically separated from one another, using the interrupt structures. It is particularly preferred, that only one antenna surface has interrupt structures and the respectively other antenna surface is free from interrupt structures, that is to say has a uniform edge, which surrounds a continuously metalized surface. Preferably, the second antenna surface has the interrupt structures. In particular, it in particular has one or more insular non-conductive free-form surfaces or is divided into a plurality of partial surfaces, which are galvanically separated from one another, by non-conductive slots. The division of the antenna surface by means of interrupt structures preferably takes place rotationally symmetrically or using a fourfold symmetry. In the same way, the antenna surfaces preferably have a rotationally symmetrical or fourfold symmetrical outline contour. Also, the feed-in locations are preferably arranged in a fourfold symmetrical arrangement. Furthermore, it is possible to laterally offset the antenna surfaces. It is in particular provided that the lateral dimensions of the second antenna surface are larger than the lateral dimensions of the first antenna surface. In particular, the total area of the second antenna surface may be larger than the total area of the first antenna surface. Also, the characteristic lengths of the two antenna surfaces, that is to say for example, a diameter or an edge length of a square, differ from one another in such a manner that the characteristic length of the second antenna surface is larger than the characteristic length of the first antenna surface. If the two antenna surfaces have a surface shape deviating from the rotational symmetry, then it is in particular provided that the antenna surfaces are arranged offset with respect to one another by an angle about the surface normal, for example by an angle of 45°. The two antenna surfaces may therefore be formed by square surfaces in each case, the central points of which lie above one another, but are rotated by 45° with respect to one another. The feed-in locations are—with respect to the central point of the first antenna surface—arranged symmetrically. The dimensions or the characteristic length of the first antenna element, that is to say the first antenna surface, is preferably half of the guided wavelength of the proper operating frequency. Also, the second antenna element is designed such that the dimensions thereof, particularly the characteristic length thereof, corresponds to half of the wavelength of the proper operating frequency. The feed-in locations of the feed network are preferably designed such that the feed-in points of mutually connecting microstrips have a length which corresponds to the phase shift, so that virtually an ideal circular polarization of the entire antenna structure is achieved. The axial ratio of the planar antenna according to the invention is below 1 dB at a proper operating frequency between 840 MHz and 960 MHz. In a particularly interesting frequency range of between 900 MHz and 930 MHz, the axial ratio is even below % dB.

### BRIEF DESCRIPTION OF THE DRAWINGS

In the following, the invention is explained in more detail on the basis of a plurality of exemplary embodiments. In the figures:

FIG. 1 schematically shows the plan view onto a first antenna surface 1, which has a square outline, and, dot-dashed, the feed network 7 arranged below the first antenna 1,

FIG. 2 shows the plan view onto a circuit board 10, the second antenna 11, which is divided by means of slots 16, 17, arranged in a cross-shaped manner, into four individual fields, which are galvanically separated from one another,

FIG. 3 shows a section, according to lines III-III in FIGS. 1 and 2, of an antenna arrangement according to the invention of a first exemplary embodiment,

FIG. 4 shows the region IV in FIG. 3 enlarged,

FIG. 5 shows the feed network,

FIGS. 6a to 6d show four different variants for shaping the outline of a first antenna surface 1, further variants, which are not illustrated, are provided, in which the first antenna surface 1 has a square and a circular outline,

FIGS. 7a to 7h show eight different variants for shaping a second antenna surface 11 with insular interrupt structures 18,

FIGS. 8a to 8c show three different design variants of a second antenna surface 11, having slot-shaped interrupt structures 16, 17, which divide the antenna surface 11 into a total of four identical partial surfaces, in a cross-shaped arrangement,

FIG. 9 shows a further exemplary embodiment of the invention in an exploded illustration,

FIG. 10 schematically shows a section through the exemplary embodiment illustrated in FIG. 9,

FIG. 11 shows a further exemplary embodiment of a circuit board as support of the antenna surface 1 and the reflection surface 5.

### DETAILED DESCRIPTION

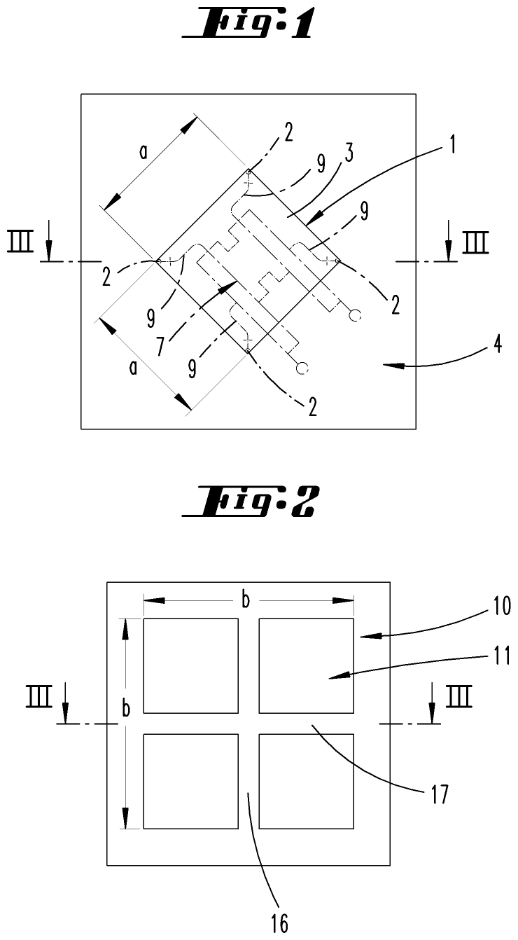

FIGS. 1 to 5 show a first exemplary embodiment of a device according to the invention, which is an antenna arrangement for communicating with an RFID tag in the 900 MHz band. A circuit board 4 carries a first coating on its front side, which is structured to form a square. The square metal surface 3 forms a first antenna surface 1, the corner points of which form feed-in locations 2. The feed-in locations 2 spaced from one another with the edge length a are used for feeding in phase-shifted AC voltage signals with a frequency, which has the following relationship with the edge length a: The edge length a corresponds to approximately half of the guided wavelength, that is to say the wavelength reduced by the electric constant of the circuit board.

A rear metalization of the circuit board 4 lying opposite the metal surface 4, forms a reflection surface 5, which extends substantially over the entire surface of the circuit board 4. With respect to the direction of action labeled with W in FIG. 3, a further dielectric body 6, likewise in the form of a circuit board with a further metalization, is located above the reflection surface 5, that is to say above the dielectric body 4, which separates the first antenna surface 1 from the reflection surface 5. This metalization is structured with microstructures as a feed network 7. FIG. 5 shows the individual microstrips 9, 14 of the feed network 7. The microstrips 9, 14 have such a length, that an AC voltage signal fed in at a connector 12 or 13, has a phase at the feed-in locations 2 shifted by 90° with respect to the adjacent feed-in location 2 in each case. Feeding an AC voltage signal into the connector 12 leads to a counterclockwise wave. Feeding an AC voltage signal into the connector 13 leads to a clockwise wave. The simultaneous feeding in of two same-sized AC voltage signals into both connectors 12 and 13 leads to a linearly polarized wave. The polarization direction is determined by the electrical phase difference of the two same-sized AC voltage signals and can be set in such a manner that, for a defined reference plane, one horizontally and one vertically polarized wave is created.

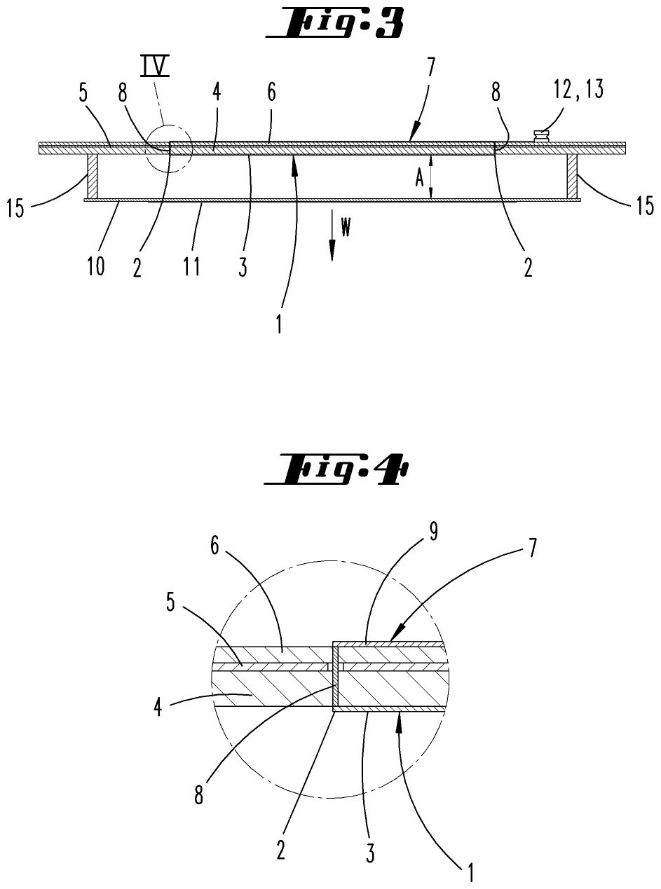

It can be drawn from FIG. 4, that the first antenna surface 1 is galvanically connected to the feed network 7 at the feed-in locations 2, by means of contact elements 8. The contact elements 8 form feed-in elements, which pass through openings of the metalization of the reflection surface 5.

They are through-contacted in particular.

FIG. 2 shows a second circuit board 10, which is structured with a second antenna surface 11. The second antenna surface 11 likewise has a square outline, but with an edge length b, which is larger than the edge length a. However, the edge length b has the same relationship with the operating frequency of the antenna arrangement, but with respect to the dielectric constant of the space A between first antenna surface 1 and second antenna surface 11. The edge length b corresponds to approximately half of the free-space wavelength. Optional spacers 15 are provided for spacing the first antenna surface 1 from the second antenna surface 11, which spacers connect the circuit board 10 to the circuit board 4. The spacers 15 may be manufactured from metal or a dielectric material. The length thereof defines the size of the spacing clearance A.

The second antenna surface 11 is divided into four rectangular surfaces, which are of the same size, by means of two intersecting slots 16, 17. The slots 16, 17 intersect at the central point of the outline of the second antenna surface 11.

Whilst the spacing of the first antenna surface 1 from the reflection surface 5 is approximately 0.5 to 3 mm, preferably 1.5 mm, the spacing between first antenna surface 1 and second antenna surface 11 is approximately 0.5 to 2 cm. The spacing A (FIG. 3) is smaller than a quarter of the vacuum wavelength of the operating frequency, for example the average frequency of the 900 MHz band. In order to build the entire antenna arrangement as flat as possible, it is provided in a particularly preferred embodiment of the invention, that the spacing A between first antenna surface 1 and second antenna surface 1 is smaller than a tenth of the air wavelength of the operating frequency, which air wavelength is approximately 30 cm. The printed circuit board arrangement 4, 6, 10 may be constructed by a three-layer printed circuit board, which has a material thickness of approximately 2 mm, so that the microstrips 9, 14 of the feed network 7 are spaced 2 mm from the first antenna surface 1 and the reflection surface 5 runs between microstrip arrangement 9, 14 and first antenna surface 1.

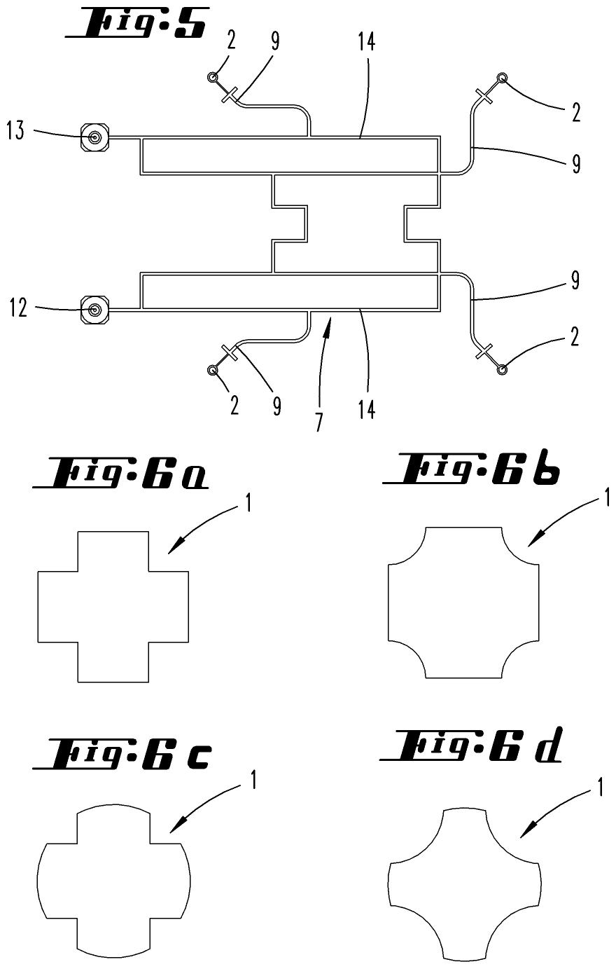

FIGS. 6a to 6d show cross-shaped arrangements of the first antenna surface. In an exemplary embodiment, which is not preferred, it is provided that the second antenna surface 11 also has outline contours of this type. The outline contour line of the antenna surfaces illustrated in FIGS. 6a to 6d surround an interruption-free continuously metalized surface. The outline contour of the antenna surface may however also be square or circular.

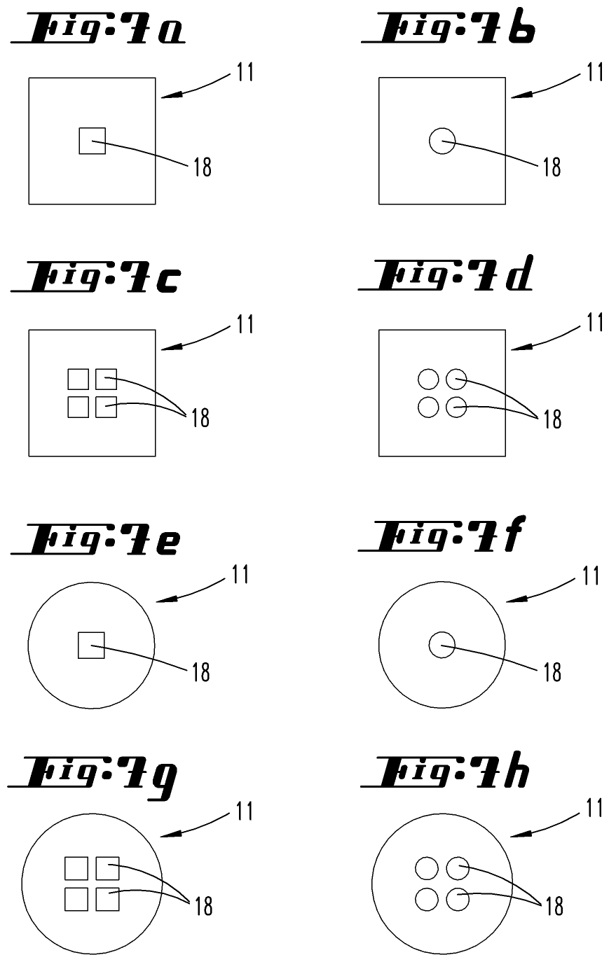

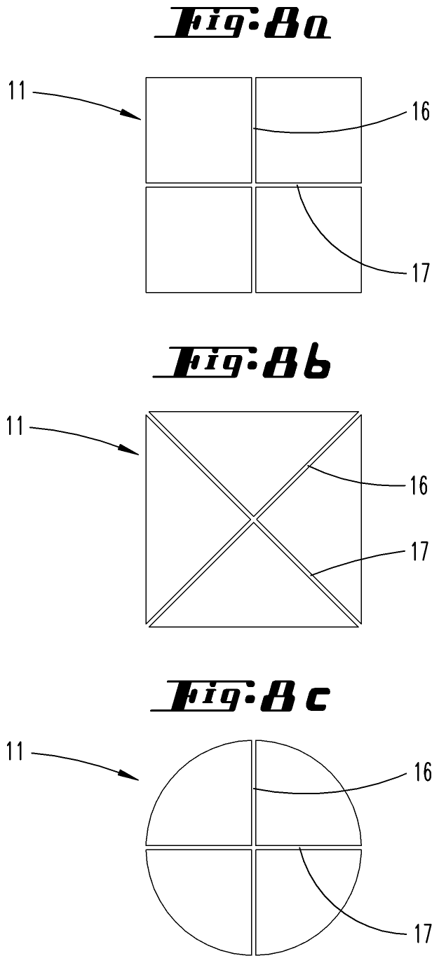

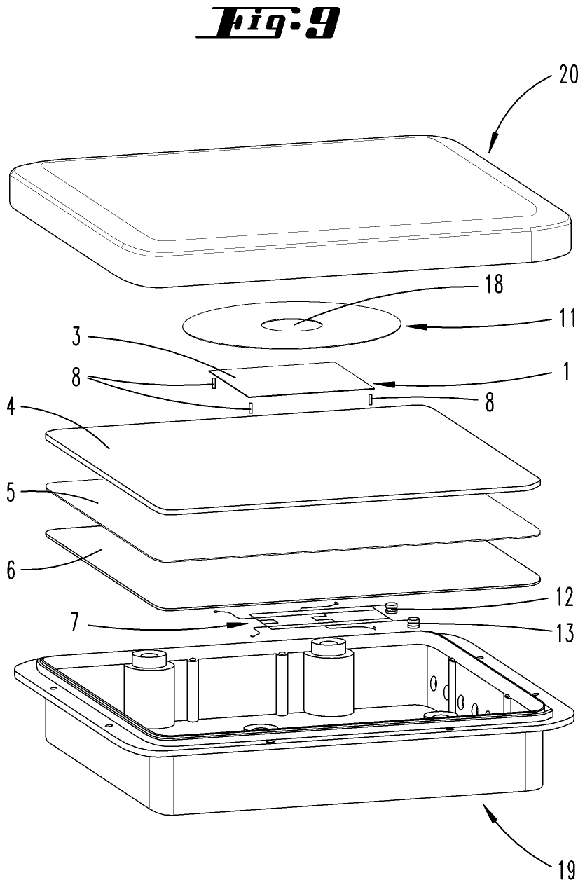

FIGS. 7a to 7h show antenna surfaces, which differ from one another, as can preferably be constructed by the second antenna surface 11. The outlines of the antenna surfaces surround a metalized surface, which forms non-metalized islands 18. The islands 18 may be arranged in the region of the center of the square or round antenna surfaces 11. The outlines of the islands 18 may be square or round. A plurality of islands 18, which are separated from one another, with a round or square outline are arranged in fourfold symmetry around the central point of the antenna surface 11.

The FIGS. 8a to 8c show antenna surfaces 11, which are separated into galvanic metal surfaces, which are not connected to one another, by means of intersecting slots 16, 17. The FIGS. 8a, 8b show square antenna surfaces 11, which are divided into four equally sized surface sections in each case, wherein the slots 16, 17 pass through the central point of the antenna surface 11. Whilst in FIG. 8a, the slots 16, 17 run parallel to the edges of the square, the slots 16, 17 run through the corners of the square antenna surface 11 in the exemplary embodiment illustrated in FIG. 8b.

FIG. 8c shows a round antenna surface 11, which is divided into four quadrant areas by means of the slots 16, 17.

The FIG. 9 shows a further exemplary embodiment of the invention. The antenna arrangement is arranged in a housing consisting of a housing base part 19 and a housing cover part 20. The housing base part 19 can consist of metal. By contrast, the housing cover 20 consists of a dielectric material, particularly a plastic.

A three-layered printed circuit board 4, 6 is arranged in the housing 19, 20. The two dielectric layers of the printed circuit board 4, 6 separate three metalization layers. A metalization, lying uppermost, with a square metal surface 3, forms a first antenna surface 1, which is galvanically connected by means of feed-in elements 8 to a feed network 7. The feed network 7 is constructed by a lower metalization of the multilayer printed circuit board, which is structured to form microstrips 9, 14 and are fastened to the connectors 12, 13.

The second antenna surface 11 has a circular outline with a central window 18, which is not metalized. The second antenna surface 11 is fastened on the inwardly facing underside of the cover surface of the housing cover 20. The fastening may take place by means of adhesive bonding, clipping or some other means. The second antenna surface 11 is galvanically separated from the first antenna surface 1.

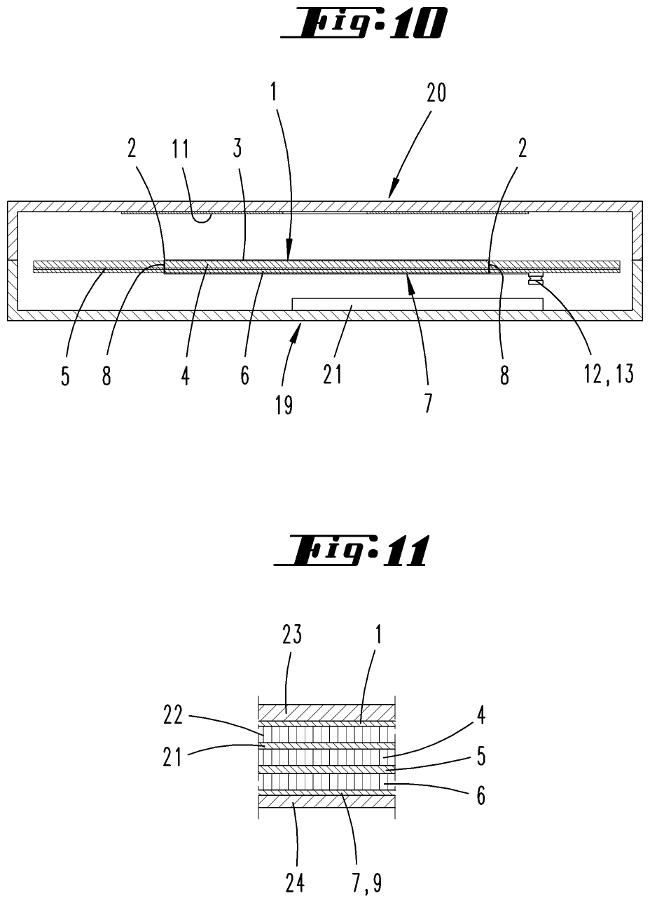

In the previously described exemplary embodiments, the printed circuit board arrangement 4, 6 is constructed by a three-layer printed circuit board. The circuit boards 4, 6 may have considerably different thicknesses. For example, the circuit board 4 may have a thickness of 1.5 mm and the circuit board 6 may have a thickness of 0.36 mm. To increase the mechanical stability of this printed circuit board arrangement, a four-layer printed circuit board is provided in the exemplary embodiment illustrated in FIG. 11. A further metalization 21, in the form of an essentially all-over metal layer, made from copper for example, is located between the antenna surface 1 and the reflection surface 5. This metalization 21 is electrically insulated with respect to the reflection surface 5 by a dielectric body 4 and electrically insulated with respect to the antenna surface 1 using a dielectric body 22. The feed-in elements 8, using which electric signals from the feed network 7, which is spaced from the reflection surface 5 by means of a dielectric body 6, are transmitted onto the metal surface 3, in this case penetrate both the both the reflection surface 5 and the further metalization 21 in an insulating manner.

In this exemplary embodiment, the further metalization 21 can have no electrical function. This is a “dummy” metalization, which mechanically stabilizes the entire arrangement.

It is provided in particular that the thickness of the dielectric body 4 is approximately 0.36 mm. The thickness of the further dielectric body 22 may be approximately 1.19 mm. It is however also provided that the thickness of the further dielectric body 22 is approximately 0.36 mm and that of the dielectric body 4 is approximately 1.19 mm.

In the FIG. 11, further metalizations are labeled with the reference numbers 23, 24, which extend on the upper side or on the underside of the multilayered printed circuit board. To a certain extent, they cover the exposed surfaces of the antenna surface 1 and the feed network 7. The metalizations 23, 24 are separated by insulation layers, which are not illustrated, from the antenna surface 1 or the feed network 7.

In the exemplary embodiment illustrated in FIG. 11, from a technical viewpoint, this is therefore a symmetrical four-layer printed circuit board having a core, which is 1.19 mm thick, and a so-called prepreg, which is 0.36 mm thick, on each side. The total material thickness of this laminate body is approximately 2 mm.

The preceding statements serve to explain the inventions encapsulated overall by the application, which inventions also in each case independently develop the prior art at least by means of the following feature combinations, wherein two, a plurality or all of these feature combinations may also be combined, namely:

A device for data exchange with and for energy transmission to a transponder, having a first antenna surface 1 for transmitting and receiving electromagnetic waves with a frequency greater than 500 MHz, particularly with a frequency in the 900 MHz band (900+/−60 MHz) in or from a direction of action W,
having a reflection surface 5 extending parallel to and, with respect to the direction of action W, to the rear of the first antenna surface 1, which reflection surface has a first spacing with respect to the first antenna surface 1, which corresponds to the material thickness of a body 6 arranged between first antenna surface 1 and reflection surface 5,
having a feed network 7, which has microstrip structures 9 arranged to the rear of the reflection surface 5, with respect to the direction of action W, with a second spacing from the reflection surface 5, for providing phase-shifted AC voltage signals, which are coupled in such a manner into the first antenna surface 1, at a plurality of mutually different feed-in locations 2 by means of the feed-in elements 8 penetrating the reflection surface 5 in an insulated manner, that the electromagnetic waves transmitted by the first antenna surface 1 are circularly polarized,
having a second antenna surface 11, which is spaced from the first antenna surface 1 with a third spacing in the direction of action W, which is smaller than a quarter of the wavelength resulting with the dielectric constant in the space between first and second antenna surface and is larger than the first spacing,
wherein at least one of the two antenna surfaces 1, 11 is formed by a metal surface interrupted by interrupt structures 16, 17, 18.

A device, which is characterized in that only one of the two antenna surfaces 1, 11 has interrupt structures 16, 17, 18 and the respectively other antenna surface 1, 11 is formed by a continuous metal surface.

A device, which is characterized in that the second antenna surface 11 has the interrupt structures 16, 17, 18 and the first antenna surface 1 is a closed metal surface.

A device, which is characterized in that the space A between the first antenna surface 1 and the second antenna surface 11 is essentially an air space.

A device, which is characterized in that the outline of the first antenna 1 and/or the second antenna 11 is a circle or a regular polygon, particularly with a fourfold symmetry.

A device, which is characterized in that the interrupt structures are rotationally symmetrical or have a fourfold symmetry and in particular are formed by a circular area or intersecting slots 16, 17.

A device, which is characterized in that the feed-in locations 2 are arranged in a fourfold symmetry.

A device, which is characterized in that the first spacing is smaller than 3 mm and larger than 0.5 mm and/or in that the second spacing is smaller than 3 mm and larger than 0.1 mm and/or in that the third spacing is larger than 0.5 cm and smaller than 2 cm.

A device, which is characterized in that the first antenna surface 1, the reflection surface 5 and/or the microstrips 9 are in each case formed by a metal layer of a multilayered circuit board 4, 6, 10.

A device, which is characterized by an additional metal layer 21 arranged between the antenna surface 1 and the reflection surface 5 in an insulated manner by means of dielectric bodies 4, 22.

A device, which is characterized in that the total length of extent of the device measured in the direction of action W is smaller than 1/10 of the wavelength with respect to the vacuum and a frequency of 900+/−60 MHz.

A device, which is characterized in that the device is arranged in a housing consisting in particular of a housing base part 19 and a housing cover part 20, wherein the second antenna surface 11 is constructed as a metalization of the, in particular, dielectric housing cover part 20.

All of the disclosed features (in their own right, but also in combination with one another) are essential for the invention. The content of the disclosure of the associated/attached priority documents (copy of the prior application) is hereby also included in full in the disclosure of the application, also for the purpose of including features of these documents in claims of the present application. With their features, the dependent claims characterize stand-alone inventive developments of the prior art, particularly in order to carry out partial applications on the basis of these claims. The invention specified in each claim may additionally have one or more of the features specified in the preceding description, which are provided with reference numbers in particular and/or specified in the list of reference numbers. The invention also relates to designs, in which some of the features mentioned in the preceding description are not realized, particularly to the extent that they can be recognized as dispensable for the respective intended use or can be replaced by other means which act in the same technical way.

1. A device for data exchange with and for power transmission to a transponder, having a first antenna surface for transmitting and receiving electromagnetic waves with a frequency greater than 500 MHz, or with a frequency in the 900 MHz band (900+/−60 MHz) in or from a direction of action,
having a second antenna surface, which is spaced from the first antenna surface with a third spacing in a direction of action, which is smaller than a quarter of the wavelength resulting with a dielectric constant in a space between first and second antenna surface and is larger than a first spacing,
wherein at least one of the two antenna surfaces is formed by a metal surface interrupted by interrupt structures,
having a feed network, which has a microstrip structure, for providing phase-shifted AC voltage signals, which are coupled in such a manner into the first antenna surface, at a plurality of mutually different feed-in locations by means of feed-in elements, that the electromagnetic waves transmitted by the first antenna surface are circularly polarized,
characterized by
a reflection surface extending parallel to and, with respect to the direction of action, to the rear of the first antenna surface, which reflection surface has the first spacing with respect to the first antenna surface, which corresponds to the material thickness of at least one body arranged between first antenna surface and reflection surface and which is spaced with a second spacing from the microstrip structures and is penetrated by the feed-in elements in an insulating manner at the feed-in locations.

2. The device according to claim 1, wherein only one of the two antenna surfaces has interrupt structures and the respectively other antenna surface is formed by a continuous metal surface.

3. The device according to claim 1, wherein the second antenna surface has the interrupt structures and the first antenna surface is a closed metal surface.

4. The device according claim 1, wherein the first antenna and the second antenna surface is essentially an air space.

5. The device according to claim 1, wherein the outline of the first antenna and/or the second antenna is a circle or a regular polygon, particularly with a fourfold symmetry.

6. The device according to claim 1, wherein the interrupt structures are rotationally symmetrical or have a fourfold symmetry and in particular are formed by a circular area or intersecting slots.

7. The device according to claim 1, wherein the feed-in locations are arranged in a fourfold symmetry.

8. The device according to claim 1, wherein the first spacing is smaller than 3 mm and larger than 0.5 mm and/or in that the second spacing is smaller than 3 mm and larger than 0.1 mm and/or in that the third spacing is larger than 0.5 cm and smaller than 2 cm.

9. The device according to claim 1, wherein the first antenna surface, the reflection surface and/or in that the strips of the microstrip structure is in each case formed by a metal layer of a multilayered circuit board.

10. The device according to claim 1, characterized by an additional metal layer arranged between the antenna surface and the reflection surface in an insulated manner by means of dielectric bodies.

11. The device according to claim 1, wherein the total length of extent of the device measured in the direction of action is smaller than 1/10 of the wavelength with respect to the vacuum and a frequency of 900+/−60 MHz.

12. The device according to claim 1, wherein the device is arranged in a housing consisting in particular of a housing base part and a housing cover part, wherein the second antenna surface is constructed as a metalization of the, in particular, dielectric housing cover part.

13. (canceled)
